(19) United States
(12) Patent Application Publication
(10) Pub. No.: US 2009/0088162 A1
(43) Pub. Date: Apr. 2, 2009

(54) Method and system for supporting IP Multimedia Subsystem for voice call continuity based on media-independent handover

(75) Inventors: Zheng Wen Zhao, Suwon-si (KR); Jeong-Jae Won, Hwaseong-si (KR); Young-Seok Kim, Seongnam-si (KR); Eui-Seok Hwang, Hwaseong-si (KR); Peng Lei, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/284,923

(22) Filed: Sep. 26, 2008

(30) Foreign Application Priority Data
Sep. 28, 2007 (KR) 2007-0097831

(51) Int. Cl. H04W 36/00

(52) U.S. Cl. 455/436

(57) ABSTRACT

Provided is a method and system for supporting IMS VCC based on an MIH. In a method of supporting a multimedia service for an MIH-based VCC, neighbor network information is obtained from an MIH server periodically or according to an event trigger and scanning the neighbor network. The capacity of at least one more candidate networks is detected from the scanning results to prepare a handover. A target network is determined among the candidate networks to reserve resources and a handover command event is generated to perform a domain transfer. The handover is completed after the performing of the domain transfer.

### CROSS-REFERENCE TO RELATED APPLICATION(S) AND CLAIM OF PRIORITY

This application claims priority under 35 U.S.C. §119 to an application filed in the Korean Intellectual Property Office on Sep. 28, 2007 and assigned Serial No. 2007-97831, the contents of which are incorporated herein by reference.

### TECHNICAL FIELD OF THE INVENTION

The present invention relates generally to IP Multimedia Subsystem (IMS) Voice Call Continuity (VCC) and, in particular, to a method and system for supporting IMS VCC based on a Media-Independent Handover (MIH).

### BACKGROUND OF THE INVENTION

Integration of a wired/wireless data network with a mobile communication network (i.e., fixed mobile convergence (FMC)) aims at providing users with a consistent and seamless service regardless of the communication network types. The distinction between voice and data is eliminated because of the widespread use of third-generation (3G) mobile communications and multimedia communications. In this context, the FMC integrates services for Unlicensed Mobile Access (UMA) networks, such as mobile communication networks, wired telephone networks, Bluetooth, Wireless Local Area Networks (WLANs), and Ultra Wide Band (UWB) based on Internet Protocol (IP). The initial attention to FMC started with the IP Multimedia Subsystem (IMS) standard (i.e., the next-generation multimedia service based standard of the 3rd Generation Partnership Project (3GPP) standardization organization).

The ultimate goal of FMC pursued by the 3GPP is to link all heterogeneous networks to an IP core network, to provide an integrated service through the IMS, and to comply with the IMS VCC as the standard for providing a seamless service between UMA networks such as mobile communication networks and wired telephone networks. Meanwhile, a UMA-based seamless service providing method is being standardized as an intermediate stage evolving into the integrated IMS.

FIG. 1 is a diagram illustrating a conventional VCC reference model.

Referring to FIG. 1, a VCC application server (AS) 103 is introduced and an IMS controlled in a call procedure is defined, thereby maintaining VCC. To this end, a voice call is controlled by a Call Continuity Control Function (CCCF) element present in an IMS domain. This means that calls originated from a circuit switching (CS)-based cellular domain, which were controlled by a Mobile Switching Center (MSC) 116, is controlled in the IMS domain. The MSC 116 needs to route all the calls, originated from the CS-based cellular domain, to the CCCF element. This is performed by the VCC AS 103 present in the IMS domain.

In the scenario of a handover from a Voice-over-IP (VoIP) network to a CS network, it is assumed that a VoIP call is initially established between a Multi-Mode Terminal (MMT) 120 and an Other End Point (OEP) through a serving base station (BS) 115 and packet data switch 114. When the MMT 120 is located near a coverage boundary of a serving network, it transmits a call origination message through a target base station (BS) 118 to the network in order to initiate a handover. The MSC 116 performs an authentication process and generates a call origination trigger in the VCC AS 103. The VCC AS 103 determines a domain switch together with network entities, such as a Home Location Register (HLR) 101, a Media Gateway Control Function (MGCF) 112, Call/Session Control Functions 105, 106 and 111, and Wireless Intelligent Network Service Control Point (WIN SCP) 102, and performs a domain transfer. In this process, a Media Gateway (MGW) 113 interprets routing information and a bearer path updated by opinion exchange between the VCC AS 103 and the OEP. After establishment of a new opinion exchange, the VCC AS 103 transmits a SIP release message to the MMT 120. The new bearer path passes through the MSC 116 and the MGW 113.

In the scenario of a handover from a CS network to a VoIP network, a basic signaling process is similar to that described above. After a domain transfer process, the MGW 113 is disregarded in a bearer path, and new routing information is updated by opinion exchange between the OEP and the VCC AS 103.

The Institute of Electrical and Electronics Engineers (IEEE) 802.21 standard provides a framework that enables seamless service continuity while a User Equipment (UE) is switching between heterogeneous link layer. This framework depends on a Media-Independent Handover Function (MIHF) performed by both the network entities such as a UE, a BS, and an Access Service Network-GateWay (ASN-GW). Also, an MIH server is introduced in a home network in order to support an MIH information service.

The MIHF provides upper layers and lower layers with an asymmetric service, such as a Media-Independent Event Service (MIES), and a symmetric service, such as a Media-Independent Command Service (MICS), through a well-defined Service Access Point (SAP). Also, the MIHF provides a Media-Independent Information Service (MIIS) that provides information about homogeneous or heterogeneous networks present in a certain geographical area.

As described above, in order to support a domain transfer between IMS and CS cellular networks during a voice call service, a multi-mode terminal needs to transmit a call origination message to a target network in order to perform a handover by triggering a mobile event. However, research is not yet being conducted on how the terminal generates and transmits the trigger message.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide a call origination method and system for allowing a UE to trigger a VCC process.

Another object of the present invention is to provide a method and system for guaranteeing a seamless VCC service.

Still another object of the present invention is to provide a method and system for supporting an IMS VCC service based on an MIH.

According to an aspect of the present invention, a method of supporting a multimedia service for an MIH-based VCC comprises: obtaining neighbor network information from an MIH server periodically or according to an event trigger and scanning the neighbor network; detecting the capacity of at least one more candidate networks from the scanning results to prepare a handover; determining a target network among the candidate networks to reserve resources, and generating a handover command event to perform a domain transfer; and completing the handover after the performing of the domain transfer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a conventional VCC reference model;

FIGS. 2A and 2B illustrate a process for a domain transfer from a WLAN VoIP network to a CDMA2000 1x CS network according to an embodiment of the present invention;

FIG. 3 is a flow chart illustrating a process for supporting an MIH-based IMS VCC according to an embodiment of the present invention;

FIGS. 4A to 4D illustrate a process for a signal strength-based voice call handover from an IMS network to a CS network according to an embodiment of the present invention; and

FIGS. 5A to 5D illustrate a process for a policy-based voice call handover from a CS network to an IMS network according to an embodiment of the present invention.

### DETAILED DESCRIPTION OF THE INVENTION

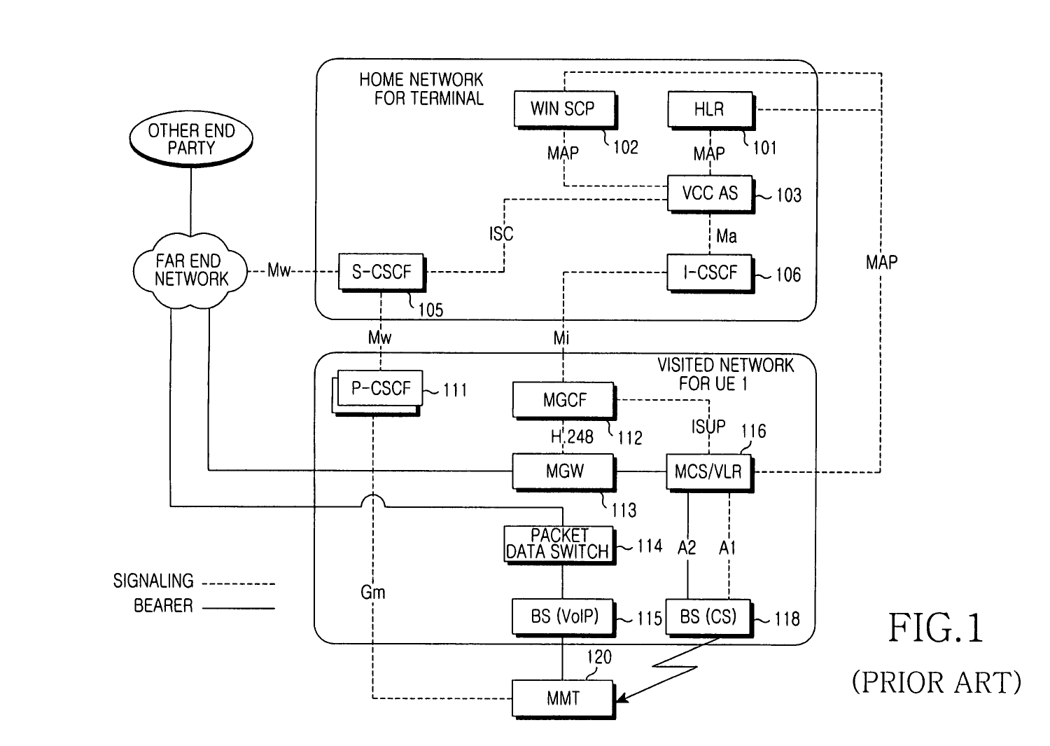

FIGS. 1 through 5D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network.

The present invention is intended to provide a method and system for supporting IP Multimedia Subsystem (IMS) Voice Call Continuity (VCC) based on a Media-Independent Handover (MIH). The VCC controls a domain selection process and a domain switch process in a core network, and the MIH manages handover initiation and neighbor network information search in a User Equipment (UE) and a radio access network (e.g., a base station (BS) or an Access Service Network-Gateway (ASN-GW)).

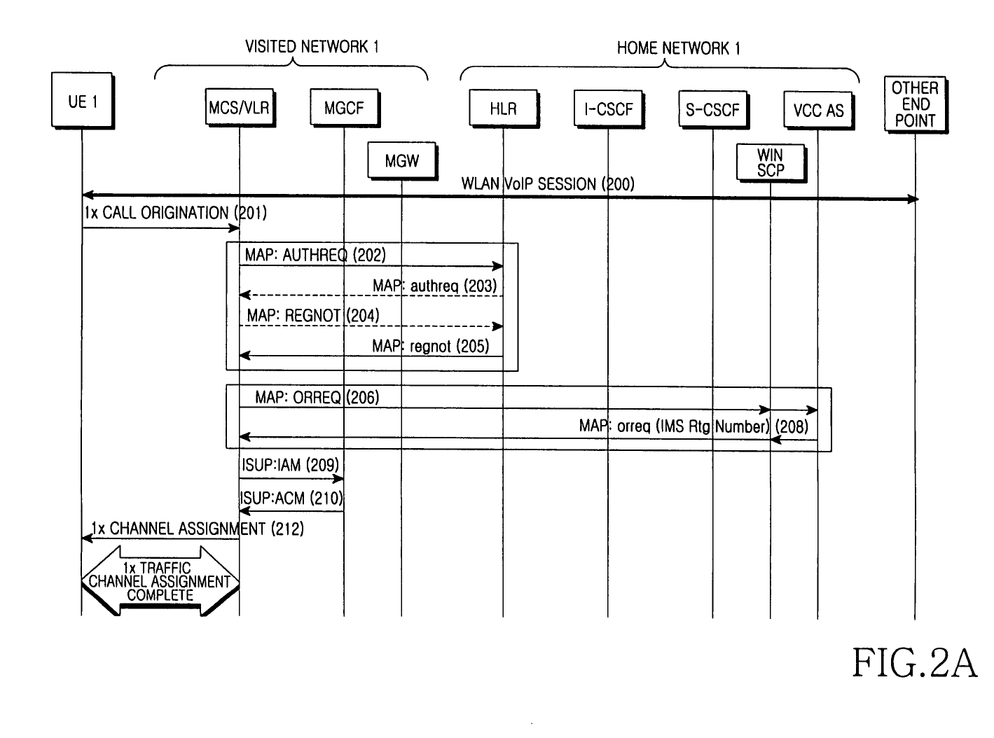

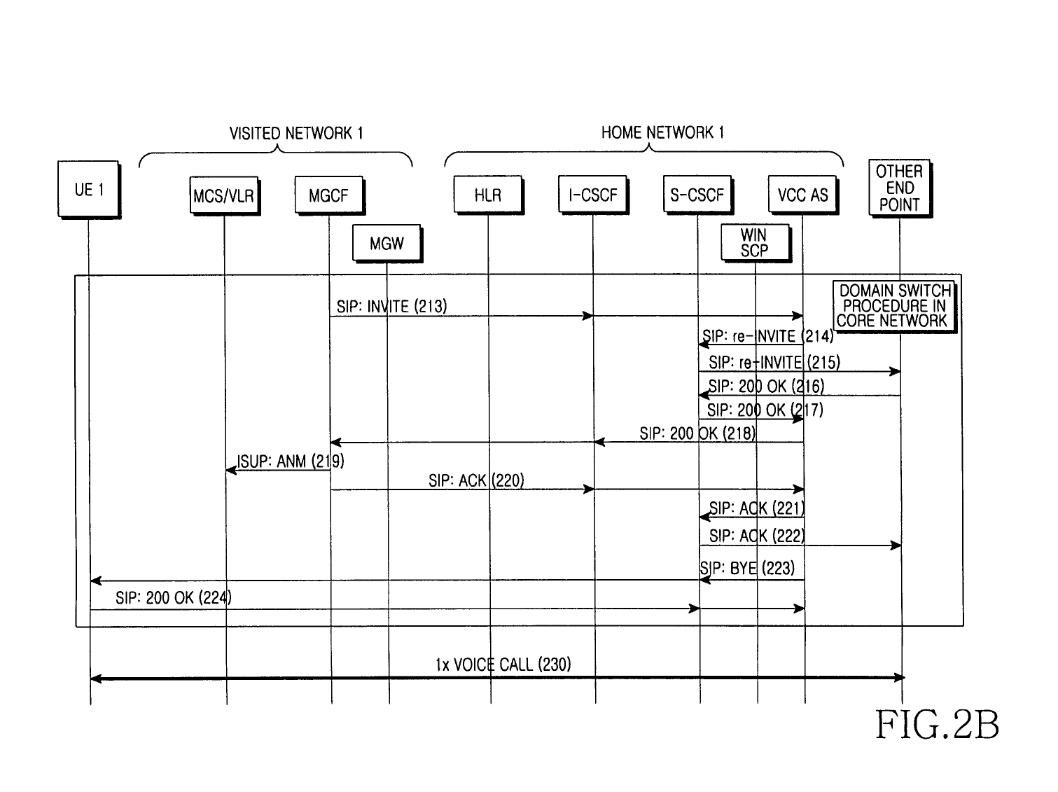

FIGS. 2A and 2B illustrate a process for a domain transfer from a WLAN VoIP network to a CDMA2000 1x Circuit Switching (CS) network according to an embodiment of the present invention. Herein, it is assumed that a User Equipment (UE) 1 is a multi-mode terminal supporting a WLAN and a CDMA2000 1x CS system and is successfully assigned a VoIP session 200 through an Other End Point (OEP) (e.g., an IMS user and a PSTN MGCF/MGW). That is, the UE performs a VoIP service through a WLAN.

Referring to FIGS. 2A and 2B, when a handover from the WLAN to the 1x CS network is needed, the UE transmits a 1x call origination message to an MSC/VLR in step 201.

In step 202, before approving registration and assigning a 1x traffic channel, the MSC/VLR transmits an AUTHREQ message to a Home Location Register (HLR) in order to authenticate the UE.

In step 203, the HLR transmits an authreq message to the MSC/VLR in response to the AUTHREQ message.

In step 204, the MSC/VLR transmits a REGistration NOTification (REGNOT) message for location registration to the HLR.

In step 205, the HLR transmits a regnot message to the MSC/VLR in response to the REGNOT message.

In step 206, the MSC/VLR transmits an ORigination REQuest (ORREQ) message containing an origination number and a termination number to a VCC AS through a Wireless Intelligent Network Service Control Point (WIN SCP). That is, the MSC/VLR obtains a service profile for an origination subscriber (e.g., through step 203) and requests a call origination trigger in order to obtain routing information.

In step 208, by referring to the called number (and the calling number) contained in the ORREQ message, the VCC AS determine whether to perform a domain transfer, and assigns an IP Multimedia Subsystem (IMS) routing number. Thereafter, the VCC AS transmits an orreq message to the MSC/VLR through the WIN SCP.

In step 209, based on an operation policy according to interpretation of the called number, the MSC/VLR transmits an ISDN User Part (ISUP) Initial Address Message (IAM) message to a Public Switched Telephone Network (PSTN) or a Media Gateway Control Function (MGCF) present in a serving network.

In step 210, based on a local policy, the MGCF transmits an Address Complete Message (ACM) message to the MSC/VLR in response to the IAM message. The MGCF requests a Media GateWay (MGW) to generate two terminations. The first termination is a connection between the visited MGW and the visited MSC. The second termination is a Real-time Transport Protocol (RTP)/User Datagram Protocol (UDP)/IP ephemeral termination.

In step 212, the MSC/VLR transmits a 1x channel assignment message to the UE through a base station (BS). Step 212 may occur at any time after step 201.

In step 213, the MGCF transmits a SIP INVITE message containing a Request-URI (Uniform Resource Identifier), a P-Asserted-ID and a Session Description Protocol (SDP) offer to the VCC AS through an interrogating CSCF (I-CSCF). The Request-URI is based on an IAM called number, the P-Asserted-ID is based on an IAM calling number, and the SDP offer is based on the visited MGW SDP information. Step 213 may occur at any time after step 209. Herein, the I-CSCF is the first access point of the UE to a home network, and several I-CSCFs may be present in one network domain. Also, a SIP INVITE message received from a Serving CSCF (S-CSCF) is routed to the S-CSCF.

In step 213′, in order to determine which subscriber terminal performs a WLAN VoIP-to-1x CS voice domain transfer (DT), the VCC AS detects a P-Asserted-Identify header of the INVITE and transmits an SIP Session Progress message to the MGCF.

In step 214, the VCC AS transmits an SIP re-INVITE message, which contains an SDP offer based on the visited MGW SDP information and a Request-URI originated from the OEP, to the S-CSCF. In step 215, the S-CSCF forwards a re-INVITE message to the OEP. The S-CSCF is a subsystem that controls a session of the UE. The S-CSCF registers a subscriber in a Home Subscriber Service (HSS), downloads subscriber information, and stores/manages a service profile. Also, the S-CSCF manages a register user session state and performs a control service. For example, the S-CSCF transmits a call request message to a home domain of a termination user through a dialed called number or a termination URL. Thereafter, the S-CSCF transmits a response message received from the I-CSCF/MGCF to a Proxy CSCF (P-CSCF) or the I-CSCF.

In step 216, the OEP corrects its own RTP bearer termination according to the visited MGW SDP and transmits an SIP 200 OK message containing an SDP answer having OEP SDP information to the S-CSCF. In step 217, the S-CSCF forwards a SIP 200 OK message to the VCC AS.

In step 218, the VCC AS transmits an SIP 200 OK message an SDP answer having OEP SDP information to the MGCF through the I-CSCF.

In step 219, the MGCF requests a change of an ephemeral termination using the OEP SDP information. To this end, the MGCF transmits an ISUP ANM (Address Completion Message) message to the MSC/VLR.

In step 220, the MGCF transmits a SIP ACK message to the VCC AC through the I-CSCF. This completes the establishment of a SIP call session between the MGCF and the VCC AS. The VCC AS records the location of the UE in a 1x CS domain.

In step 221, the VCC AS transmits a SIP ACK message to the S-CSCF. In step 222, the S-CSCF forwards a SIP ACK message to the OEP.

In step 223, the VCC AS transmits a SIP BYE message, which is used to terminate a generated SIP session, to the UE through the S-CSCF.

In step 224, the UE transmits a SIP 200 OK message through the S-CSCF to the VCC AS in response to the SIP BYE message. Accordingly, the UE performs a 1x voice call (230) with the OEP.

Herein, steps 213 to 224 correspond to a domain switch procedure in a core network.

Thereafter, the domain transfer process is ended.

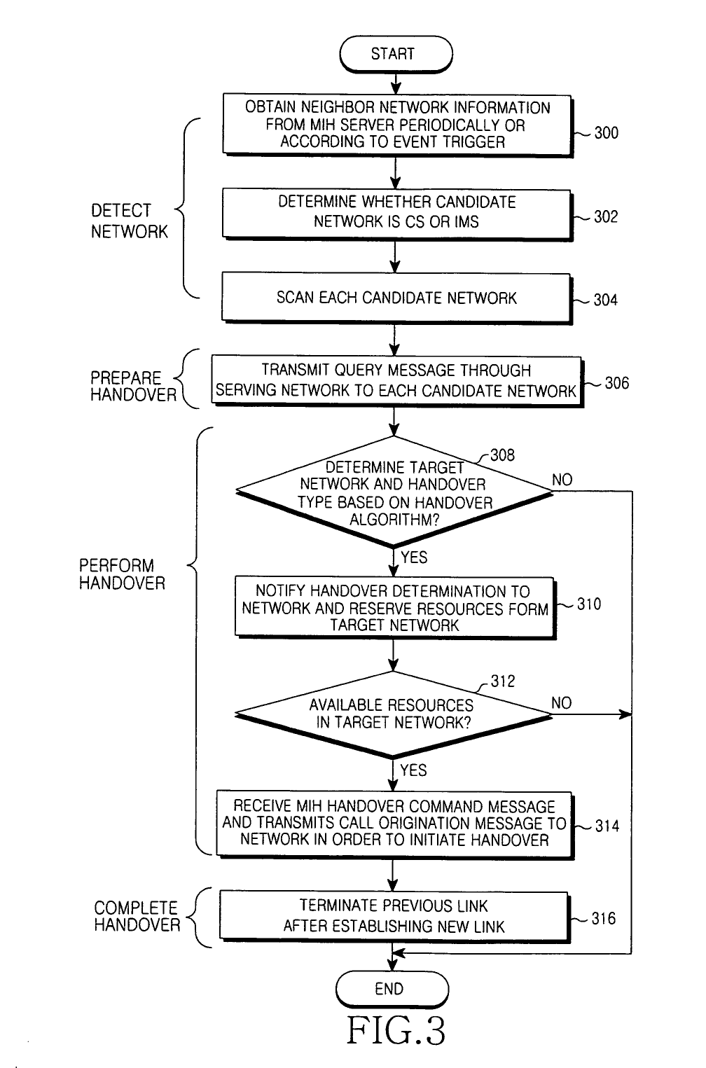

FIG. 3 illustrate a process for supporting an MIH-based IMS VCC according to an embodiment of the present invention.

Referring to FIG. 3, in step 300, a UE obtains neighbor network information from an MIH server periodically or according to an event trigger.

In step 302, based on the obtained neighbor network information, the UE determines whether a candidate network is a CS or an IMS. That is, the UE determines whether it performs a voice call through a CS or receives an IMS-based VoIP service.

In step 304, the UE scans each candidate network to obtain information about a physical layer and a link layer (e.g., a signal strength).

In step 306, the UE transmits a query message through a serving network to each candidate network to detect the network capacity.

In step 308, based on a handover algorithm, the UE determines a target network and a handover type.

In step 310, the UE notifies the handover determination to the network (the target network or the serving network) and reserves resources of the target network.

In step 312, the UE determines whether there are available resources in the target network. If there are available resources in the target network (in step 312), the process proceeds to step 314. In step 314, by being triggered by an MIH handover command message, the UE transmits a call origination message to the network in order to initiate a handover. Herein, a domain transfer process is initiated and performed in the core network according to the call origination message transmitted to the target network.

In step 316, the UE terminates the previous link after establishing a new link.

Thereafter, the process is ended.

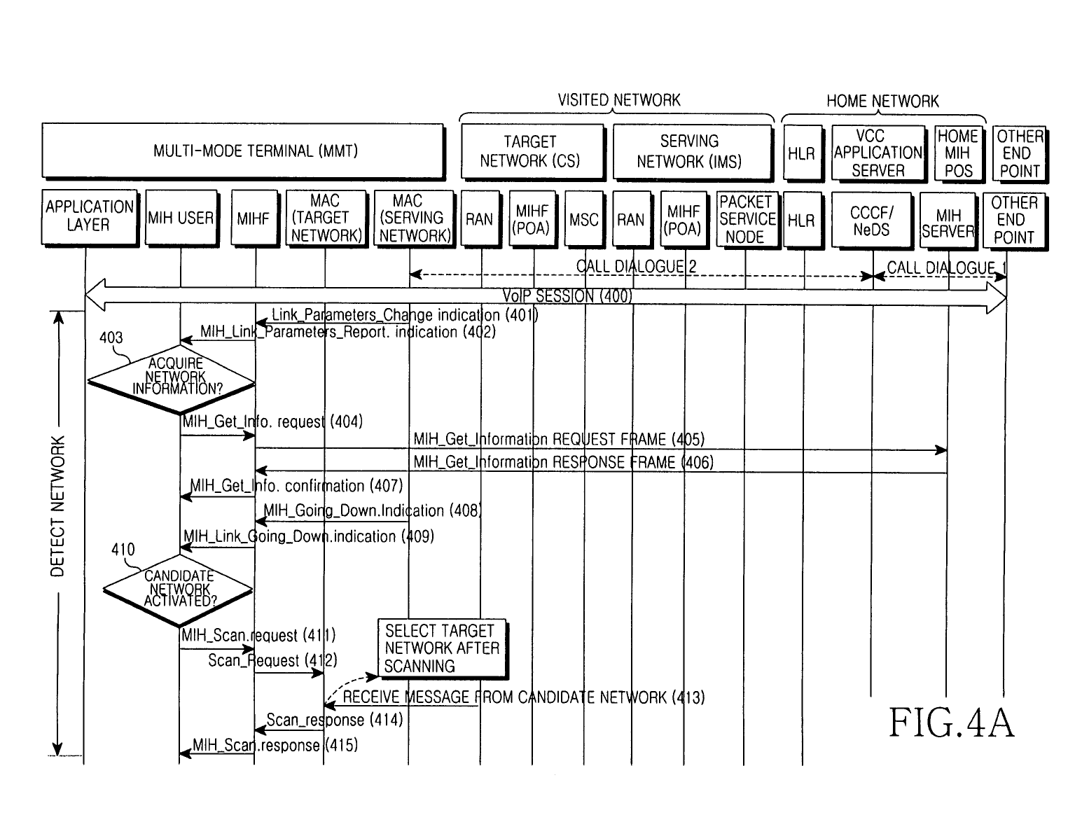

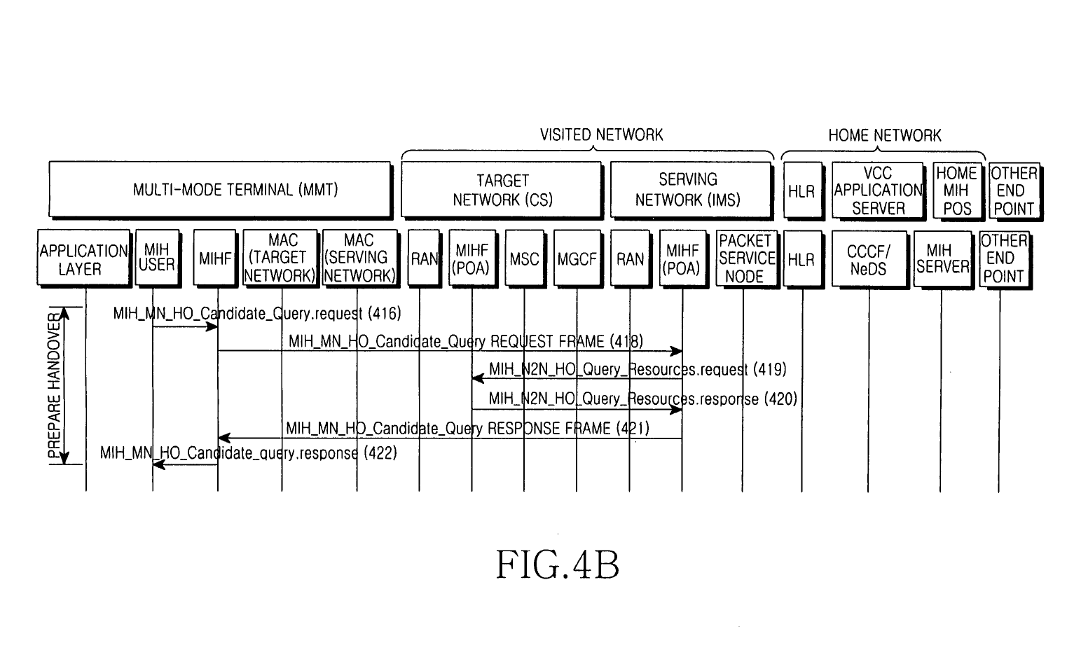

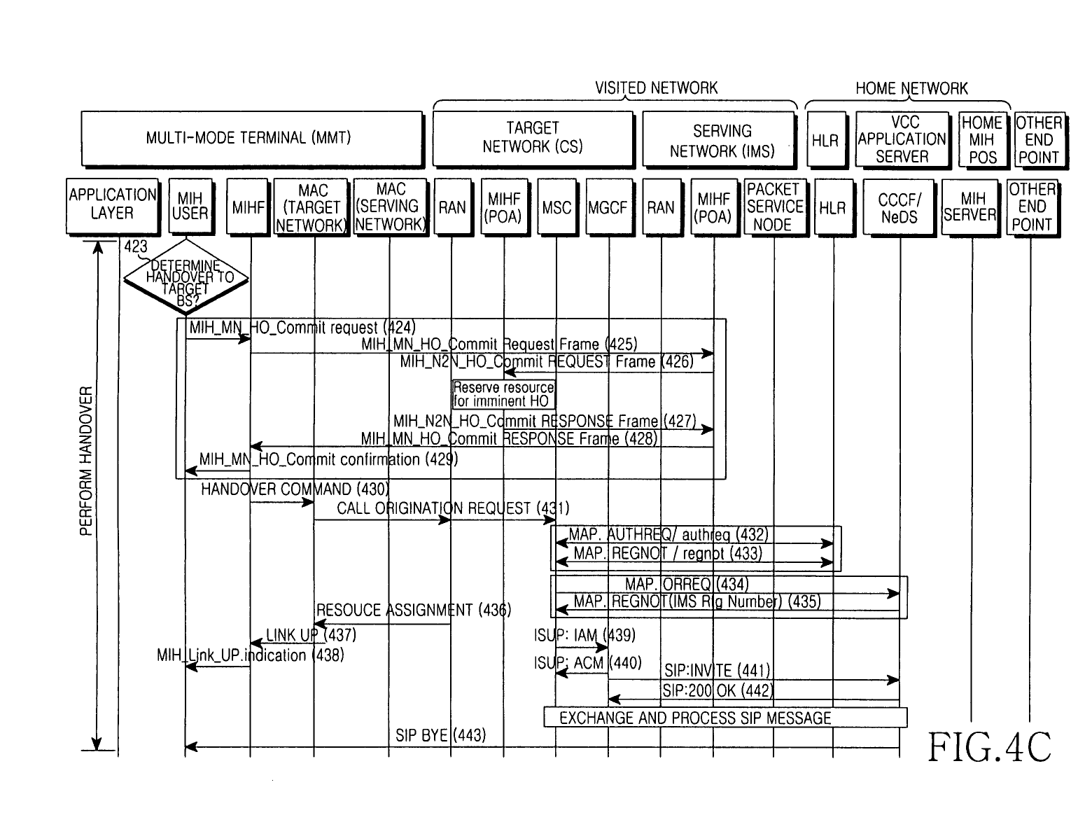

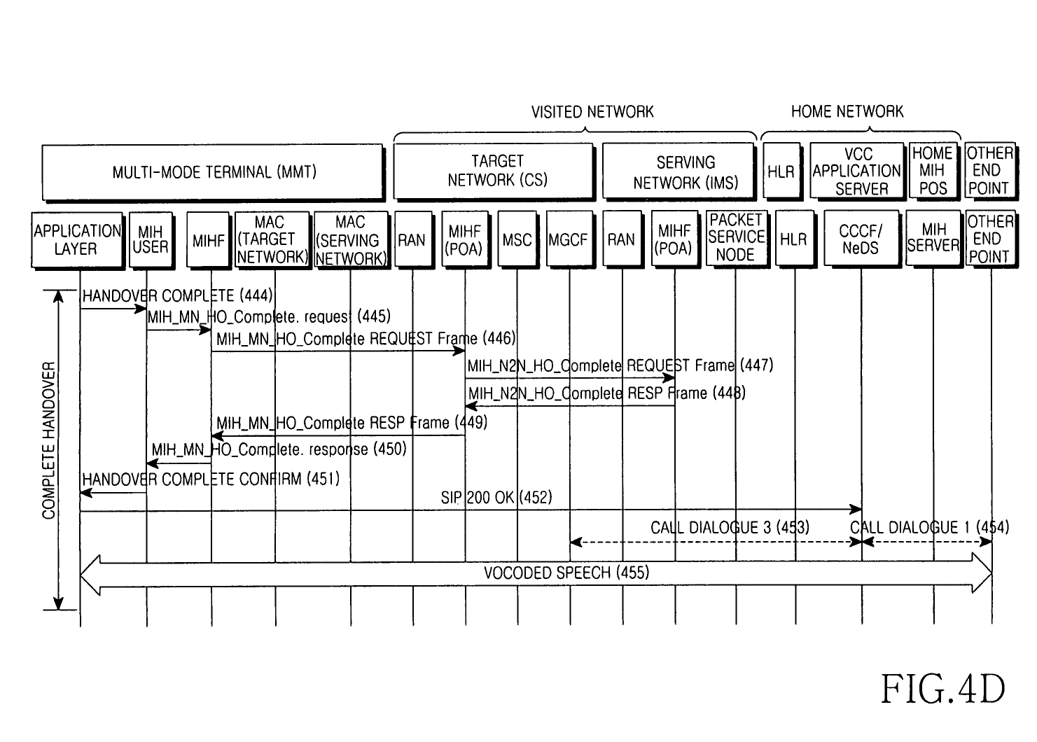

FIGS. 4A to 4D illustrate a process for a signal strength-based voice call handover from an IMS network to a CS network according to an embodiment of the present invention.

Referring to FIGS. 4A to 4D, it is assumed that a VoIP session for a UE is established in a serving network (an IP-based IMS network) through a VCC AS in step 400.

In step 401, a MAC layer of the serving network triggers a link parameter change event due to a change in a radio channel. That is, a Link_Parameters_Change_Indication link event is transmitted to an MIHF.

Instep 402, the MIHF transmits an MIH link parameter report indication MIH event (MIH_Link_Paramters_Report_Indication) to an MIH user.

In order to obtain network information in step 403, the MIH user transmits an information request MIH command (MIH_Get_Info. request) to the MIHF in step 404.

In step 405, the MIHF transmits an information request message (MIH_Get-Information REQUEST FRAME) to an MIH server.

In step 406, the MIH server transmits an information response message (MIH_Get_Information RESPONSE FRAME) to the MIHF.

In step 407, the MIHF transmits an MIH event (MIH_Get_Info. confirmation) to the MIH user. The MIH user can be connected to the MIH server according to the event and/or the command, and the MIH user can obtain general network information, access network information, Point of Attachment (POA) information, and upper layer information according to a Query/Response.

Thereafter, the MAC layer of the serving network triggers a link down event (MIH_Going_Down. Indication) due to the degradation of signal quality when the UE continues to move out of the coverage area of the serving network. That is, in step 408, the MAC layer of the serving network transmits an MIH_Going_Down. Indication link event to the MIHF.

In step 409, the MIHF transmits a link down MIH command (MIH_Link_Going_Down. Indication) to the MIH user.

In order to activate a candidate network in step 410, the MIH user transmits a scan request MIH command (MIH_scan.request) to the MIHF in step 411. Herein, the MIH user can detect a neighbor network by performing a scanning process.

In step 412, the MIHF transmits a scan request (Scan_request) link command to a MAC layer of a target network.

In step 413, the MAC layer of the target network receives a broadcast message from a Radio Access Network (RAN) of the target network to receive the target network physical layer/link layer information. The target network may be selected after a scanning process.

In step 414, the MAC layer of the target network transmits a scan response (Scan_response) link event to the MIHF.

In step 415, the MIHF transmits a scan response MIH event (MIH_Scan_response) to the MIH user.

In step 416, the MIH user transmits an MIH command (MIH_MN_HO_Candidate_Query.request), which is used to detect the capacity of a candidate network obtained from the scanning process, to the MIHF to prepare a handover.

In step 418, the MIHF transmits an MIH_MN_HO_Candidate_Query.REQUEST FRAME message, which is used to detect the capacity of a candidate network, to an MIHF (POA) of a serving network (IMS).

In step 419, the MIHF (POA) of the serving network (IMS) transmits a response message (MIH_N2N_HO_Query_Resources.request), which is used to detect the capacity of a candidate network, to an MIHF (POA) of a target network (CS).

In step 420, the MIHF (POA) of the target network (CS) transmits a link event (MIH_N2N_HO_Query_Resources. response) as a response for detecting the capacity of a candidate network to the MIHF (POA) of the serving network (IMS).

In step 421, the MIHF (POA) of the serving network (IMS) transmits a response message (MIH_MN_HO_Candidate_Query.RESPONSE FRAME) for the capacity of a candidate network to the MIHF.

In step 422, the MIHF transmits an MIH_MN_HO_Candidate_query.response MIH event to the MIH user.

In step 423, the MIH user determines a handover to a target BS on the basis of a signal strength. That is, based on available information, the MIH user determines a handover according to an information processing function including the resource reservation results and the upper layer information from the MIH server as well as the physical layer information from a scanning processor.

In step 424, the MIH user transmits an MIH command (MIH_MN_HO_Commit request) notifying a handover to a target network to the MIHF.

In step 425, the MIHF transmits an MIH_MN_HO_Commit REQUEST Frame message notifying a handover to a target network to an MIHF (POA) of a serving network.

In step 426, the MIHF (POA) of the serving network transmits a resource reservation message (MIH_N2N_HO_Commit REQUEST Frame) to the MIHF (POA) of the target network.

In step 427, the MIHF (POA) of the target network transmits a resource reservation notification message (MIH_N2N_HO_Commit RESPONSE Frame) to the MIHF (POA) of the serving network.

Instep 428, the MIHF (POA) of the serving network transmits a resource reservation notification message (MIH_MN_HO_Commit RESPONSE Frame) to the MIHF.

In step 429, the MIHF transmits an MIH command (MIH_MN_HO_Commit confirmation) notifying a handover to a target network to the MIH user.

In step 430, the MIHF transmits a Handover Command event of the MIH user to a MAC layer of a target network.

In step 431, while receiving a response message from the network, the MAC layer of the target network transmits a call origination request message to an MSC through a RAN of the target network.

In steps 432 and 433, the MSC and the HLR perform an authentication request/response. That is, when an MSC in a target network receives a call origination request message, the MSC transmits an AUTHENREQ message and receives an authenreq message in order to perform user authentication. In steps 434 and 435, the MSC and the VCC AS transmits/receives an REGNOT/regnot message in order to perform a location registration request/response.

In step 439, the MSC transmits an IAM message to an MGCF in order to perform trunk establishment in a target network. In step 440, the MGCF transmits an ACM message to the MSC in response to the IAM message.

In steps 441 and 442, the MGCF and the VCC AS exchange a SIP INVITE message and a SIP 200 OK message to perform a domain switch process, thereby connecting a session call with a target network. Accordingly, a SIP message exchange/process is performed.

In step 443, the VCC AS transmits a SIP BYE message to the MIH user to terminate an SIP session.

In step 436, a RAN of the target network transmits a resource assignment message to a MAC layer of a target network of the UE. Step 436 may be performed at any time after the call origination request in step 431.

In step 437, the MAC layer of the target network transmits a link connection event (Link Up) for the target network to the MIHF.

In step 438, the MIHF transmits a link connection indication MIH event (MIH_Link Up.indication) to the MIH user.

In step 444, an application layer of the UE transmits a Handover Complete message to the MIH user.

In step 445, the MIH user transmits an MIH command (MIH_MN_HO_Complete.request) notifying handover completion to the MIHF.

In step 446, the MIHF transmits a handover completion notification message (MIH_MN_HO_Complete.REQUEST Frame) to an MIHF (POA) of a target network.

In step 447, the MIHF (POA) of the target network transmits an MIH_N2N_HO_Complete REQUEST Frame message notifying handover completion of the UE to an MIHF (POA) of a serving network.

In step 448, the MIHF (POA) of the serving network transmits a response message (MIH_N2N_HO_Complete RESP Frame) for the handover completion notification of the UE to an MIHF (POA) of a target network.

In step 449, the MIHF (POA) of the target network transmits a response message (MIH_MN_HO_Complete.RESP Frame) for the handover completion notification to the MIHF.

In step 450, the MIHF transmits an MIH command (MIH_MN_HO_Complete.response) for the handover completion notification to the MIH user.

In step 451, the MIH user transmits a Handover Complete Confirm message to the application layer.

In step 452, the application layer of the UE transmits a SIP 200 OK message to the VCC server in response to a SIP BYE message.

Thereafter, a call dialogue between the VCC server and the MGCF of the target network is opened in step 453, and a call dialogue between the VCC server and the OEP is opened in step 454.

In step 455, a domain transfer from the IMS and the CS is performed to perform a voice service from the CS of the target network.

Thereafter, the process is ended.

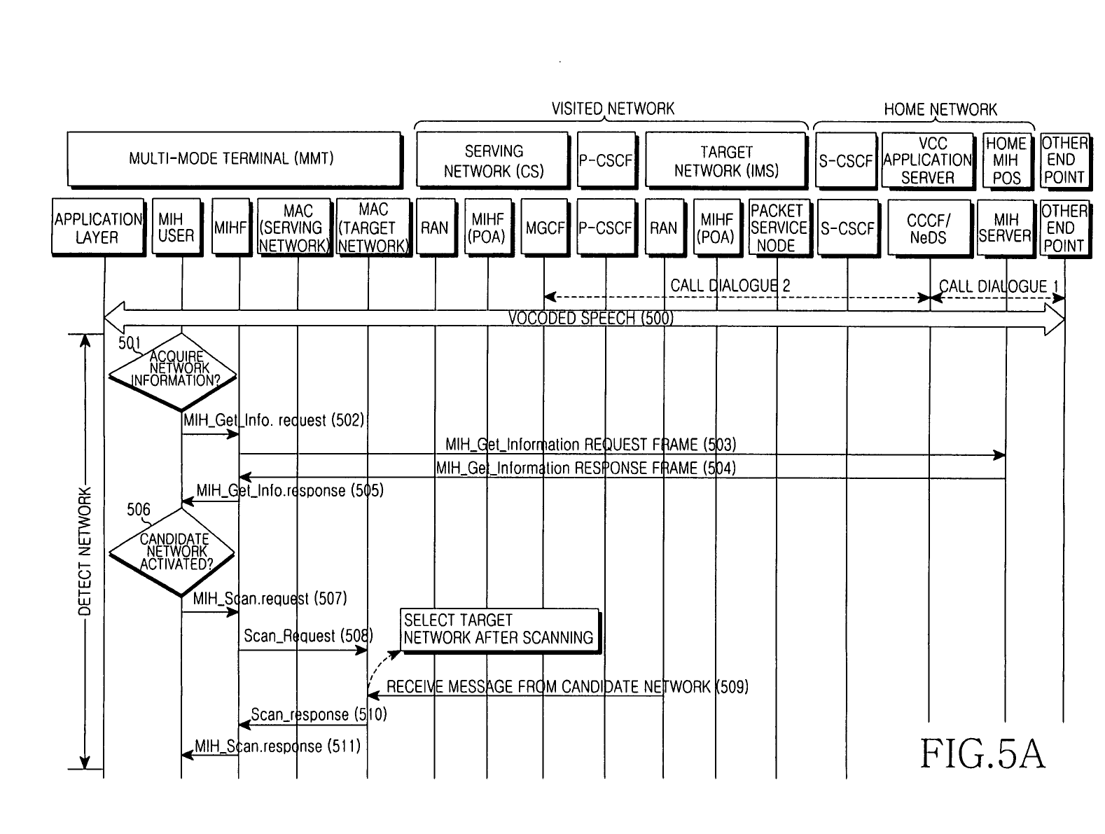

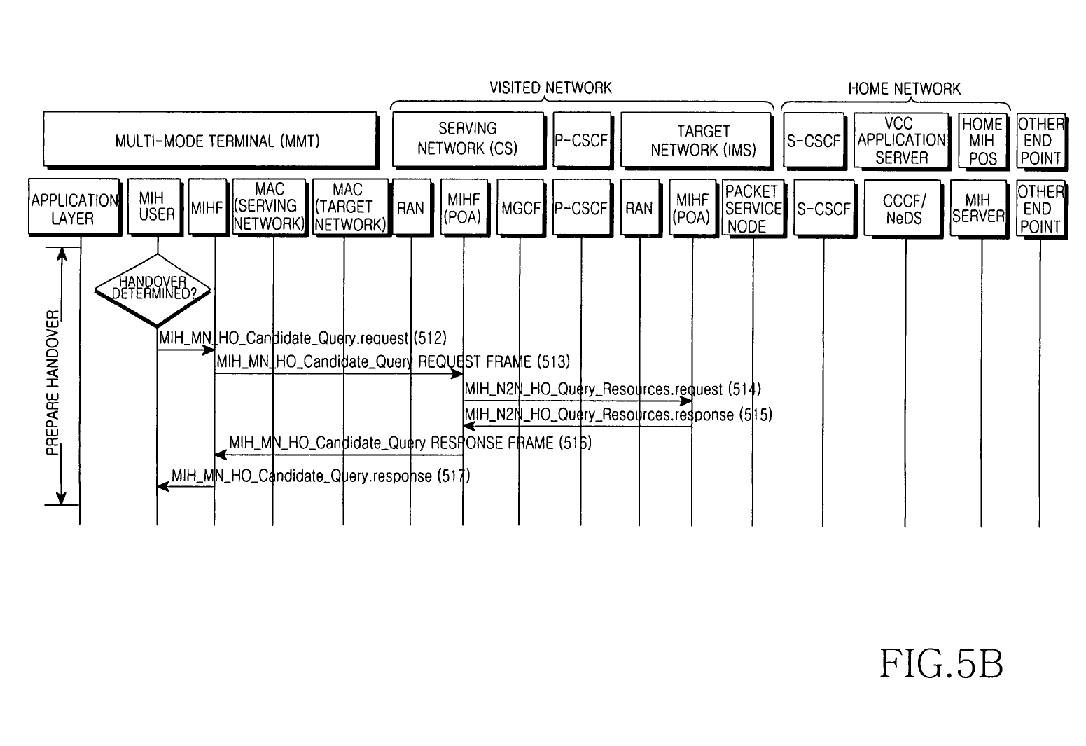

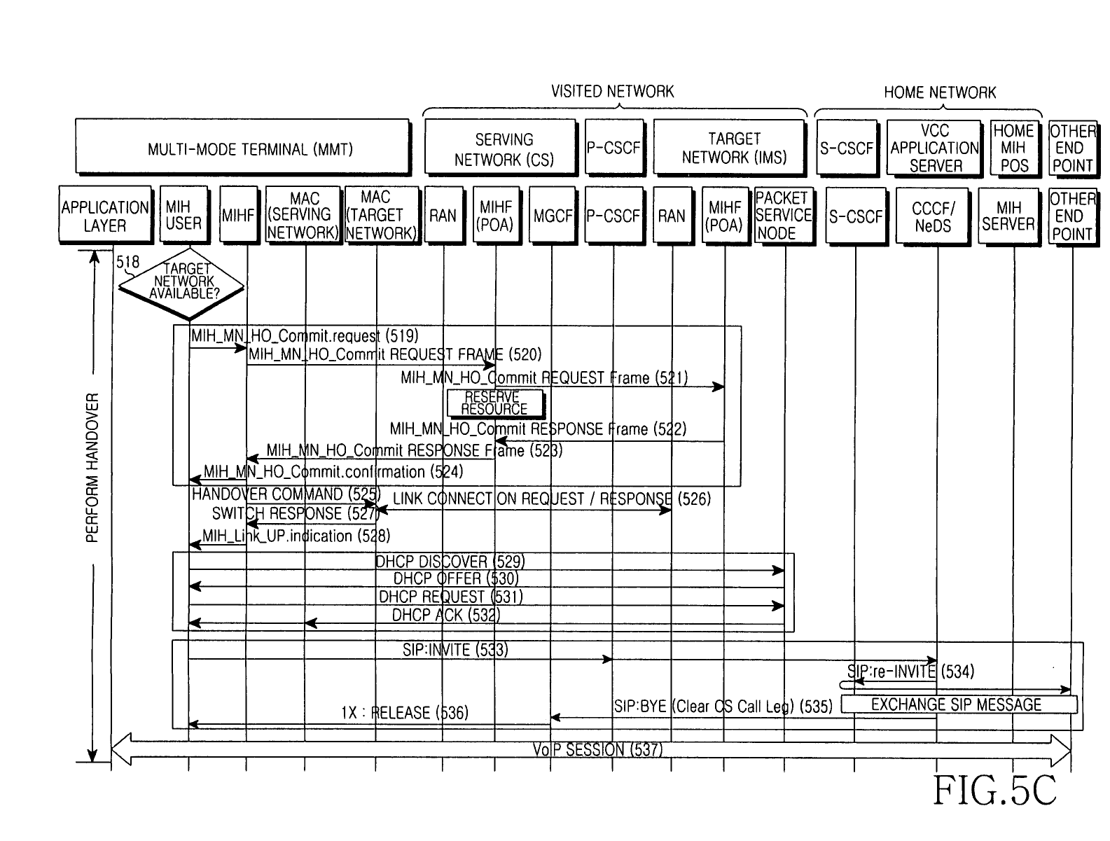

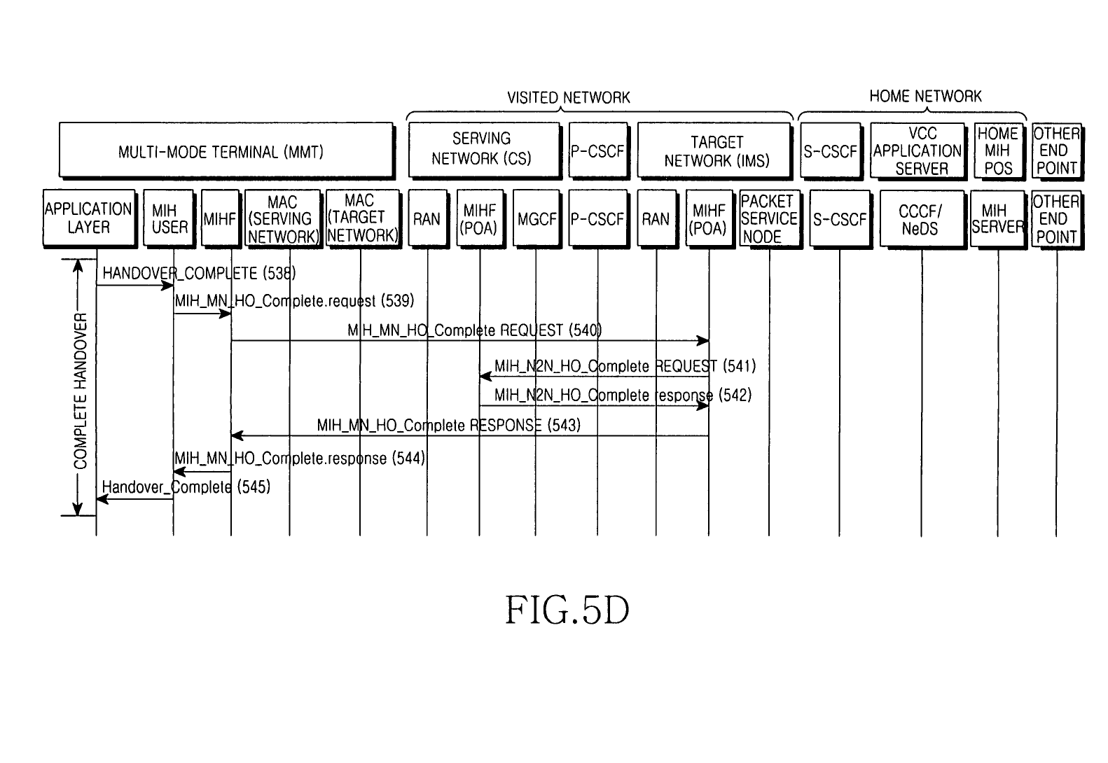

FIGS. 5A to 5D illustrate a process for a policy-based voice call handover from a CS network to an IMS network according to an embodiment of the present invention.

Referring to FIGS. 5A to 5D, it is assumed that voice call traffic for a UE is established in a serving network (a CS network) through a VCC AS in step 500.

In step 501, an MIH user of the UE periodically searches an MIH server for neighbor network information. A trigger operation may be performed by a timer set in the UE. To this end, in step 502, the MIH user transmits an information request MIH command (MIH_Get_Info.request) to the MIHF in order to obtain the network information.

In step 503, the MIHF transmits an information request message (MIH_Get-Information REQUEST FRAME) to an MIH server.

In step 504, the MIH server transmits an information response message (MIH_Get_Information RESPONSE FRAME) to the MIHF.

In step 505, the MIHF transmits an MIH event (MIH_Get_Info. response) to the MIH user. The MIH user can be connected to the MIH server according to the event and/or the command, and the MIH user can obtain general network information, access network information, Point of Attachment (POA) information, and upper layer information according to a Query/Response.

In order to activate a candidate network in step 506, the MIH user transmits a scan request MIH command (MIH_scan.request) to the MIHF in step 507. Herein, the MIH user can detect a neighbor network by performing a scanning process.

In step 508, the MIHF transmits a scan request message (Scan_request) to a MAC layer of a target network.

In step 509, the MAC layer of the target network receives a broadcast message from a Radio Access Network (RAN) of the target network to receive information necessary for scanning. The target network may be selected after a scanning process.

In step 510, the MAC layer of the target network transmits a scan response message (Scan_response) to the MIHF.

In step 511, the MIHF transmits a scan response MIH event (MIH_Scan_response) to the MIH user.

Thereafter, during preparation of a handover, a policy-based handover is triggered, and the UE determines a handover based on the priority order configured for each network. A network with a higher priority order is selected as a target network. To this end, in step 512, the MIH user transmits an MIH command (MIH_MN_HO_Candidate_Query.request), which is used to detect the capacity of a candidate network obtained from the scanning process, to the MIHF to prepare a handover.

In step 513, the MIHF transmits an MIH_MN_HO_Candidate_Query.REQUEST FRAME message, which is used to detect the capacity of a candidate network, to an MIHF (POA) of a serving network (CS).

In step 514, the MIHF (POA) of the serving network (CS) transmits an MIH_N2N_HO_Query_Resources.request message, which is used to detect the capacity of a candidate network, to an MIHF (POA) of a target network (IMS).

In step 515, the MIHF (POA) of the target network (IMS) transmits a response message (MIH_N2N_HO_Query_Resources.response) for detecting the capacity of a candidate network to the MIHF (POA) of the serving network (CS).

In step 516, the MIHF (POA) of the serving network (CS) transmits a response message (MIH_MN_HO_Candidate_Query.RESPONSE FRAME) for the capacity of a candidate network to the MIHF.

In step 517, the MIHF transmits an MIH event (MIH_MN_HO_Candidate_query.response) as a response for the capacity of the neighbor network to the MIH user.

Thereafter, if there is an available target network in step 518, the MIH user transmits an MIH command (MIH_MN_HO_Commit request) notifying a handover to a target network to the MIHF in step 519.

In step 520, the MIHF transmits an MIH_MN_HO_Commit REQUEST Frame message notifying a handover to a target network to an MIHF (POA) of a serving network.

In step 521, the MIHF (PbA) of the serving network transmits an MIH_MN_HO_Commit REQUEST Frame message notifying a handover to a target network to the MIHF (POA) of the target network.

In step 522, the MIHF (POA) of the target network transmits a response message (MIH_MN_HO_Commit RESPONSE Frame) notifying a handover to a target network to the MIHF (POA) of the serving network.

In step 523, the MIHF (POA) of the serving network transmits a response message (MIH_MN_HO_Commit RESPONSE Frame) notifying a handover to a target network to the MIHF.

In step 524, the MIHF transmits an MIH command (MIH_MN_HO_Commit confirmation) confirming a handover to a target network to the MIH user.

In step 525, the MIHF transmits a Handover Command event of the MIH user to a MAC layer of a target network.

In step 526, the MAC layer of the target network exchanges a Link Connection Request/Response message with a RAN of the target network (IMS).

In step 527, the MAC layer of the target network transmits Switch Response message to the MIHF.

In step 528, the MIHF transmits an MIH_Link_Up.Indication command to the MIH user.

Thereafter, in order to allocate an IP address from a DHCP server, an application layer of the UE transmits a DHCP Discover message to a packet service node in step 529, and the packet service node transmits a DHCP Offer message to the application layer of the UE in step 530; the application layer of the UE transmits a DHCP Request message to a packet service node in step 531, and the packet service node transmits a DHCP ACK message to the application layer of the UE in step 532.

In step 533, an application layer transmits a SIP INVITE message to a VCC AS through a P-CSCF, and the VCC AS forwards an SIP re-INVITE message to an S-CSCF.

In step 534, the S-CSCF transmits a SIP re-INVITE message to an OEP.

In step 535, the VCC AS transmits a SIP BYE message for removal of a CS call to an MGCF.

In step 536, the MGCF transmits a control message for termination of a CS call connection to the application layer.

Herein, steps 533 to 536 are a domain switching process that switches from the CS network to the IMS network to establish a VoIP session in step 537.

In step 538, the application layer of the UE transmits a Handover Complete message to the MIH user.

In step 539, the MIH user transmits an MIH_MN_HO_Complete request command to the MIHF.

In step 540, the MIHF transmits an MIH_MN_HO_Complete.REQUEST Frame message to an MIHF (POA) of a target network.

In step 541, the MIHF (POA) of the target network transmits an MIH_N2N_HO_Complete REQUEST Frame for request of a handover to the UE to an MIHF (POA) of a serving network.

In step 542, the MIHF (POA) of the serving network transmits a response message (MIH_N2N_HO_Complete response) for the handover completion request of the UE to the MIHF (POA) of the target network.

In step 543, the MIHF (POA) of the target network transmits a response message (MIH_MN_HO_Complete.RESPONSE) for the handover completion request to the MIHF.

In step 544, the MIHF transmits an MIH command (MIH_MN_HO_Complete.response) for the handover completion request to the MIH user.

In step 545, the MIH user transmits a Handover Complete message to an application layer.

Thereafter, the process is ended.

As described above, the multi-mode UE of the present invention supports an MIH-based IMS VCC service, thereby making it possible to provide an IMS VCC service support solution to the UE.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of supporting a multimedia service for a Media-Independent Handover (MIH)-based Voice Call Continuity (VCC), the method comprising:
obtaining a neighbor network information from an MIH server periodically or according to an event trigger and scanning a neighbor network;
detecting a capacity of at least one more candidate networks from the scanning results to prepare a handover;
determining a target network among the candidate networks from which to reserve resources, and generating a handover command event to perform a domain transfer; and
completing the handover after performing the domain transfer.

2. The method of claim 1, wherein obtaining a neighbor network information comprises:
transmitting, upon establishing a current voice over Internet Protocol (VoIP) session, a link event for a link parameter change indication from a Media Access Control (MAC) layer of a serving network to an MIH function (MIHF) and transmitting an MIH event of a link parameter report indication from the MIHF to an MIH user;
transmitting an MIH command for a network information request from the MIH user to the MIH function and transmitting a message for a network information request from the MIH function to an MIH server; and
receiving, by the MIH function, a response message for the network information request from the MIH server and transmitting an MIH event for a network information request confirmation to the MIH user.

3. The method of claim 2, further comprising transmitting a link down indication link event from the MAC layer of the serving network to the MIH function in case of a degradation of a signal quality and transmitting an MIH event for a link down indication from the MIH function to the MIH user.

4. The method of claim 1, wherein scanning a neighbor network comprises:
transmitting, upon establishing a current VoIP session, a scan request MIH command for an activation of a candidate network from the MIH user to the MIH function and transmitting a scan request link command from the MIH function to a MAC layer of the target network;
receiving, by the MAC layer of the target network, a physical layer/link layer information from the target network; and
transmitting a scan response link event from the MAC layer to the MIH function and transmitting a scan response MIH event from the MIH function to the MIH user.

5. The method of claim 1, wherein preparing the handover by detecting the capacity of the candidate networks from the scanning results comprises:
transmitting, upon establishing a current VoIP session, an MIH command for a detection of the capacity of the candidate network obtained from the scanning results from the MIH user to the MIH function and transmitting a link command for detection of the capacity of the candidate network from the MIH function to an MIHF of a serving network;
receiving a message for the detection of the capacity of the candidate network from the MIH function of the serving network and transmitting a response message for the detection of the capacity of the candidate network to the MIH function of the serving network;
transmitting a response message for the capacity of the candidate network from the MIH function of the serving network to the MIH function; and
receiving a response message for the capacity of the candidate network from the MIH function of the serving network and transmitting an MIH command for a response to the capacity of the candidate network to the MIH user.

6. The method of claim 1, wherein reserving resources by determining a target network among the candidate networks comprises:
determining, by the MIH user, a handover to a target base station (BS) upon establishing a current VoIP session, transmitting an MIH command for execution of the handover to the target base station to the MIH function, and transmitting a message for execution of the handover to the target base station to an MIH function of a serving network;
receiving, by the MIHF of the target network, a message for handover resource reservation from the serving network and transmitting a response message for handover resource reservation to the MIH function of the serving network; and
receiving, by the MIH function, a response message for resource reservation from the MIH function of the serving network and transmitting an MIH event for a response to execution of an handover to the target network to the MIH user.

7. The method of claim 1, further comprising:
generating the handover command event to perform a domain transfer;
if the target network is a Circuit Switching (CS) network, transmitting a handover command link event from the MIH function to an MAC layer of the target network upon establishing a current VoIP session and transmitting a call origination request from the MAC layer of the target network to the target network in order to initiate a connection establishment with the target network;
exchanging an authentication request/response message with a home network and exchanging a location registration request/response message with the home network;
establishing, by the target network, a trunk using an Initial Address Message (IAM) and an Address Complete Message (ACM);
transmitting a Session Initiation Protocol (SIP) INVITE message from the target network to the VCC server and transmitting a SIP 200 OK message for the SIP INVITE message from the VCC server to the target network to establish a SIP session call; and
transmitting a SIP BYE message from the VCC server to an application layer of a user equipment (UE) to terminate a SIP session.

8. The method of claim 7, further comprising, after the call origination request:
receiving, by a MAC layer of the target network, a resource assignment message from the target network, transmitting a link connection event (Link Up) for the target network to the MIH function, and transmitting an MIH event for link connection indication to the MIH user.

9. The method of claim 1, wherein completing the handover comprises:
transmitting a Handover Complete message from an application layer to the MIH user upon establishing a current VoIP session, transmitting an MIH command for notification of handover completion from the MIH user to the MIH function, and transmitting a link command for handover completion notification from the MIH function to an MIH function of the target network;
transmitting a link event for notification of the handover completion of a user equipment (UE) from an MIH function of the target network to an MIH function of a serving network and receiving a response message for handover completion notification from the MIH function of the serving network; and
receiving, by the MIH function, a response message for handover completion notification from an MIH function of the target network, transmitting a response MIH event for handover completion notification to the MIH user, and transmitting a handover completion confirmation message to an application layer.

10. The method of claim 9, further comprising:
transmitting a SIP 200 OK message for the SIP BYE message from the application layer to the home network.

11. The method of claim 1, wherein obtaining a neighbor network information comprises:
transmitting an information request MIH command (MIH_Get_Info.request) from an MIH user to the MIH function upon establishing a current voice call traffic and transmitting an information request message (MIH_Get Information REQUEST FRAME) from the MIH function to an MIH server; and
transmitting an information response message (MIH_Get_Information RESPONSE FRAME) from the MIH server to the MIH function and transmitting an information confirmation MIH event (MIH_Get_Info.confirmation) from the MIH function to the MIH user.

12. The method of claim 1, wherein scanning the neighbor network comprises:
if a current voice call traffic is established, transmitting a scan request MIH command (MIH_Scan.request) to the MIH function and transmitting a scan request message (Scan_request) to a MAC layer of a target network;
receiving, by the MAC layer of the target network information necessary for scanning and transmitting, a scan response message (Scan_response) from the MAC layer of the target network to the MIH function; and
transmitting a scan response MIH event (MIH_Scan_response) from the MIH function to the MIH user.

13. The method of claim 1, wherein preparing the handover comprises:
transmitting an MIH command (MIH_MN_HO_Candidate-Query.request) for detection of the capacity of a candidate network obtained from scanning from an MIH user to the MIH function, transmitting an MIH_MN_HO_Candidate_Query.REQUEST FRAME message for detection the capacity of a candidate network from the MIH function to an MIHF of a serving network (CS), and transmitting an MIH_N2N_HO_Query_Resources.request message for detection the capacity of a candidate network from an MIH function of the serving network to an MIH function of the target network; and
transmitting a response message (MIH_N2N_HO_Query_Resources.request) for detection of the capacity of a candidate network from the MIH function of the target network to the MIH function of the serving network, transmitting a response message (MIH_MN_HO_Candidate_Query.RESPONSE FRAME) for the capacity of a candidate network from the serving network of the serving network to the MIH function, and transmitting an MIH event (MIH_MN_HO_Candidate_query.response) for a response to the capacity of the neighbor network from the MIH function to the MIH user.

14. The method of claim 1, wherein reserving the resources by determining a target network among the candidate networks comprises:
if there is an available target network, transmitting an MIH command (MIH_MN_HO_Commit request) notifying a handover to a target network to from the MIH user to the MIH function, transmits an MIH_MN_HO_Commit REQUEST Frame message notifying a handover to a target network from the MIH function to an MIH function of a serving network, and transmitting an MIH_N2N_HO_Commit REQUEST Frame message notifying a handover to a target network from the MIH function of the serving network to the MIH function of the target network; and
transmitting a response message (MIH_N2N_HO_Commit RESPONSE Frame) notifying a handover to a target network from the MIH function of the target network to the MIH function of the serving network, transmitting a response message (MIH_MN_HO_Commit RESPONSE Frame) notifying a handover to a target network from the MIH function of the serving network to the MIH function, and transmitting an MIH command (MIH_MN_HO_Commit confirmation) confirming a handover to a target network from the MIH function to the MIH user.

15. The method of claim 1, further comprising:
generating the handover command event to perform a domain transfer; and
if a current voice call traffic is established, transmitting a Handover Command event from the MIH function to a MAC layer of a target network, exchanging, by the MAC layer of the target network, a Link Connection Request/Response message with and the target network, transmitting a Switch Response message from the MAC layer of the target network to the MIH function, transmitting an MIH_Link_Up. Indication command from the MIH function to the MIH user.

16. The method of claim 15, further comprising, after the transmitting of the link connection indication MIH command to the MIH user:
exchanging, by an application layer of a user equipment, a DHCP Discover message, a DHCP Offer message, a Dynamic Host Configuration Protocol (DHCP) Request message, and a DHCP acknowledgment (ACK) message with the target network to assign an IP address; and
transmitting a SIP INVITE message from the application layer to the home network to establish a SIP session;
forwarding a SIP re-INVITE message from the VCC server to an Other End Point (OEP) and transmitting a SIP BYE message for call removal to the serving network; and
transmitting a control message for termination of a call connection from the serving network to the application layer.

17. The method of claim 16, further comprising, after the transmitting of the control message for the termination of the call connection from the serving network to the application layer:
establishing a VoIP session.

18. The method of claim 1, wherein completing the handover comprises:
if a current voice call traffic is established, transmitting a Handover Complete message from an application layer of a user equipment to the MIH user, transmitting an MIH_MN_HO_Complete request command from the MIH user to the MIH function, and transmitting an MIH_MN_HO_Complete.REQUEST Frame message to an MIH function of a target network;
transmitting an MIH_N2N_HO_Complete REQUEST Frame for request of a handover to the user equipment from the MIH function of the target network to an MIH function of a serving network and transmitting a response message (MIH_N2N_HO_Complete RESP Frame) for the handover completion request of the UE from the MIH function of the serving network to the MIH function of the target network; and
transmitting a response message (MIH_MN_HO_Complete.RESP Frame) for the handover completion request from the MIH function of the target network to the MIH function, transmitting an MIH command (MIH_MN_HO_Complete.response) for the handover completion request from the MIH function to the MIH user, and transmitting a Handover Complete message from the MIH user to an application layer.
